(19) United States
(12) Patent Application Publication
(10) Pub. No.: US 2026/0022063 A1
(43) Pub. Date: Jan. 22, 2026

(54) HYDRATED SODIUM SILICATE ALUMINATE AS A BINDER AGENT FOR INORGANIC SUBSTRATES

(71) Applicant: PQ LLC, Malvern, PA (US)

(72) Inventors: Flavio Ernesto Ribeiro, Plainfield, IL (US); Ronaldo dos Santos Flor, Sao Paulo (BR); Bruna Rosa Polastro, Sao Paulo (BR); Michael McDonald, Toronto (CA); Daoping Guo, Ontario (CA)

(21) Appl. No.: 19/268,140

(22) Filed: Jul. 14, 2025

Related U.S. Application Data
(60) Provisional application No. 63/672,794, filed on Jul. 18, 2024.

(51) Int. Cl. C04B 7/32; C04B 7/42; C04B 28/06; C04B 111/00

(52) U.S. Cl. CPC C04B 7/32; C04B 7/427; C04B 28/06; C04B 2111/00215

(57) ABSTRACT

Embodiments relate to the development of binder agents, and specifically to a hydrated silicate aluminate binder agents. The binder agents, whether combined or not with hardener agents, offer significant improvements in terms of mechanical strength and water resistance compared to soluble sodium-based silicates when used as agents for inorganic and organic substrates.

### CROSS-REFERENCE TO RELATED APPLICATIONS

This patent application is related to and claims the benefit of priority of U.S. Provisional Application 63/672,794, filed on Jul. 18, 2024, the entire contents of which are incorporated by reference.

### FIELD

Embodiments relate to silicate-based binder agents enriched with aluminum-based compounds, hydrated silicate aluminate binder agents, and methods of making and using thereof. The binder agents can be used in various industries such as ceramics, mining, construction, among others. The binder agents have improved properties over traditional sodium silicate binders, offering more efficient and durable solutions for creating robust structural compositions that are resistant to adverse conditions such as extreme weather and water environments.

### BACKGROUND

Sodium silicate is an inorganic compound widely used as a binder because of its chemical, adhesive, mechanical, and curing properties. Sodium silicate is obtained from the combination of an alkali metal oxide and high purity silica in different proportions. Its general formulation is X SiO₂:M₂O, where M can be sodium (Na), potassium (K), or lithium (Li) and X is the molar ratio. Silicates are generally sold in aqueous solutions, but can also be found in solid form.

There are several methods that can be used to manufacture sodium silicate, the most conventional of which are the furnace and chemical reaction processes. In the furnace process, a siliceous material, commonly high-purity quartz, is fused with an alkali source obtained preferably from sodium carbonate (Na₂CO₃). The chemical reaction process takes place in autoclaves under high temperatures and pressure using sodium hydroxide (NaOH) as the alkali source.

In the furnace process, the raw materials are mixed in specific proportions according to the typical desired ratio, which is approximately 1 part Na₂CO₃ to 3 parts SiO₂. The raw materials are subjected to high temperatures between 1100° C.-1500° C. As shown in Equation (1), during melting, as the sodium carbonate decomposes into sodium oxide (Na₂O) and carbon dioxide (CO₂), the sodium reacts with the silica and the product obtained is a soluble amorphous form of silicate. As shown in Equation (2), the silicate glass is dissolved in an autoclave at high temperature and pressure, becoming a solution which is then filtered and adjusted in concentration, density and viscosity according to the needs of each application.

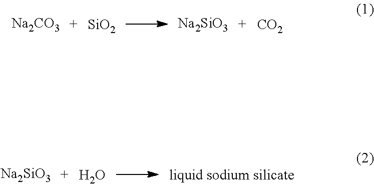

The chemical reaction process is a hydrothermal process involving synthesis from sand (SiO₂) and aqueous sodium hydroxide (NaOH) under conditions of high temperatures, pressure and time controlled in autoclaves. The reaction, shown in Equation (3), is stabilized and maintained to obtain the desired technical specification of ratio, concentration, viscosity and density.

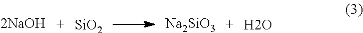

Due to its versatility, sodium silicate has a wide range of applications, such as, but not limited to detergent powder, silicas, zeolites, textiles, pulp and paper, industrial water treatment, briquette, pelletizing, foundry, civil construction, adhesives and sealants, building paints, among other applications. Sodium silicates are commonly used as binder agents in different industries. The SiO₄⁴⁻ anions can form cross-links with one another, thus creating a robust three-dimensional network. This cross-linked structure is responsible for the formation of a solid, resistant material with high adhesion strength and rapid transformation to a semi-solid state caused by a slight loss of water, which when subjected to temperature provides the substrate with optimum mechanical strength, but limited water resistance when subjected to extreme humidity and water environments.

U.S. Pat. No. 8,460,459 relates to a process for producing a chemically resistant inorganic binder for civil construction. The composition includes blast furnace slag as a hydraulic agent, amorphous silica as a reactive compound, minerals such as metakaolin for filler components, and sodium or potassium silicate as a binder.

In U.S. Pat. No. 8,567,481, a binder is provided for the production of sand molds for foundries. Sand is mixed with alkyl silicate, an aqueous solution of sodium silicate and starch. The process includes blowing the mixture under the molds and then blowing hot air to cure the binder.

U.S. Pat. No. 4,226,277 describes a sodium silicate base binder used for hardening casting molds. Adjuvant agents such as alumina, borax, clays, bentonite, iron oxide, graphite and polysaccharides such as dextrose, are used to improve the process of dehydrating and hardening the binder. The process involves a simple mechanical mixing to form the composite.

International Patent Application Publication No. WO02064846 describes the use of alkali metal silicates in combination with curing agents, preferably calcium oxide or calcium carbonate for binder particulate materials.

### SUMMARY

In industries that demand the manufacture of high-performance materials, it is desirable to use binder agents that promote high mechanical strength and water resistance. The substitution of aluminum-based compounds and hydrated silicates in silicate binder compositions enhances these properties, providing superior solutions for industries when compared to sodium silicates.

The binder agents described herein improve the characteristics of commercial sodium silicate. For example, sodium silicate is an inorganic substance formed by combining silicon dioxide (SiO₂) and oxides, most frequently sodium oxide (Na₂O). Although effective and versatile, sodium silicate has some limitations such as a high solubility index, which directly impacts water resistance for agglomerating substrates, potentially leading to reduced mechanical strength. The search for alternatives or modifications to improve these properties has become essential for applications that demand high technical performance.

The present binder agents are new compounds obtained through a specific hydration process, which incorporates aluminum oxide (Al₂O₃) into the sodium silicate structure, resulting in a complex, more robust and water-resistant binder matrix. When combined with selected inorganic minerals, the binder raises the insolubility level according to the needs of each substrate to be bound.

Surprisingly, we have found hydrated sodium silicate aluminate used as a binder agent has a more robust and complex bonding network due to the reaction of aluminum oxide (Al₂O₃) with the silicate molecule. The aluminum oxide plays a fundamental role as a network modifying agent creating more complex structures. This modified structure provides better water resistance, increasing the longevity of substrates in adverse environments. The dissolution of aluminum hydroxide in the silicate, as well as direct addition via sodium aluminate, adds Al₂O₃ to the SiO₄⁴⁻ anion network, which forms more complex structures that are less soluble when there is only the combination of SiO₂ and Na₂O.

The reactivity and ability of hydrated sodium silicate aluminate to form gels is a striking feature when subjected to dehydration temperatures, as well as when subjected to the addition of hardening agents which, concomitantly with the dehydration process, form films on the substrate to be agglomerated that are more rigid and less soluble than soluble sodium silicates. When hydrated sodium silicate aluminate reacts with other curing accelerators such as minerals, carbonaceous materials, and/or clays, it forms a rigid and insoluble gel matrix that efficiently agglomerates the particles, improving the water-and chemical-resistance and durability of the substrates when subjected to water and bad weather.

Unlike U.S. Pat. No. 8,460,458, present embodiments do not use hydraulic reinforcing agents and external sources of silica as reactive compounds. Moreover, the present invention incorporates aluminum oxide into sodium silicate with a high concentration of solids by means of a chemical reaction.

Unlike U.S. Pat. No. 8,567,481, present embodiments do not use ethyl silicate and carbohydrates such as starch in the composition.

Unlike U.S. Pat. No. 4,226,277, present embodiments include a process for dissolving aluminum oxide in the sodium silicate matrix.

Unlike International Patent Application Publication No. WO02064846, present embodiments incorporate aluminum oxide into the sodium silicate and also eliminates the need for a curing agent for the composite.

The described binder agents require chemical interaction between sodium silicate and aluminum oxide to rearrange the chemical structure of the silicate, forming a more complex, robust and stable network of cross-links.

In an exemplary embodiment, a hydrated silicate aluminate binder agent includes an alkali metal silicate selected from the group consisting of sodium silicate and potassium silicate; and aluminum oxide.

In some embodiments, the alkali metal silicate is sodium silicate having a molar ratio of SiO₂:Na₂O of from 1.1 to 1.8.

In some embodiments, the aluminum oxide is present in an amount of from 0.1 to 4.5% by weight of the agent.

In some embodiments, the alkali metal silicate is potassium silicate having a molar ratio of SiO₂:K₂O of from 1.1 to 1.35.

In some embodiments, the aluminum oxide is present in an amount of from 0.1 to 4.5% by weight of the agent.

In an exemplary embodiment, a hydrated sodium silicate aluminate binder agent includes sodium silicate having a molar ratio between 1.1 and 1.8; and at least one aluminum-based compound selected from the group consisting of aluminum oxide, aluminum hydroxide, sodium aluminate, aluminum sulfate, and aluminum chloride.

In some embodiments, the binder agent further includes at least one inorganic component selected from the group consisting of carbonates, oxides, clay minerals, sulfate minerals, phosphate minerals, cementitious or pozzolanic materials, and mixtures thereof.

In some embodiments, at least one inorganic component includes carbonates selected from the group consisting of dolomite, calcite, aragonite, natural or precipitated calcium carbonate, magnesium carbonate, limestone, and mixtures thereof.

In some embodiments, the at least one inorganic component includes clay minerals selected from the group consisting of kaolinite, kaolin, metakaolin, halloysite, bentonite, and mixtures thereof.

In some embodiments, the at least one inorganic component includes sulfate minerals selected from the group consisting of gypsum, anhydrite, and mixtures thereof.

In some embodiments, the at least one inorganic component includes oxides minerals selected from the group consisting of calcium oxide, magnesium oxide, and mixtures thereof.

In some embodiments, the at least one inorganic component includes phosphate minerals, wherein the phosphate minerals include apatite.

In some embodiments, the at least one inorganic component includes cementitious or pozzolanic materials selected from the group consisting of cement, fly ash, blast furnace slag, and mixtures thereof.

In an exemplary embodiment, a method of producing a hydrated sodium silicate aluminate binder agent includes adding at least one aluminum-based compound selected from the group consisting of aluminum hydroxide, alkaline aluminate, and aluminum oxide, to a sodium silicate solution having a molar ratio between 1.1 and 1.8; and mixing the solution to reduce aluminum hydroxide particles and facilitate reaction between the aluminum hydroxide particles and sodium silicate, thus forming the hydrated sodium silicate aluminate binder agent.

In some embodiments, adding the at least one aluminum-based compound to the sodium silicate solution includes adding between 2 and 12% by weight of aluminum hydroxide to the sodium silicate solution at a temperature greater than 50° C.

In some embodiments, the method further includes adjusting one or more properties of the hydrated sodium silicate aluminate binder agent, wherein the one or more properties are selected from the group consisting of: solids concentration of the aluminate, wherein the solids concentration is adjusted to be between 30-55% by weight, viscosity of the aluminate, wherein the viscosity is adjusted to be between 550 and 4500 centipoise, and molar ratio of the aluminate, wherein the molar ratio is adjusted to be between 1.30 and 1.67.

### BRIEF DESCRIPTION OF THE FIGURES

The above and other objects, aspects, features, advantages, and possible applications of the present invention will be more apparent from the following more particular description thereof, presented in conjunction with the following drawings. It should be understood that like reference numbers used in the drawings may identify like components.

FIG. 1 depicts an exemplary flow diagram describing a method of preparing an exemplary binder agent.

FIG. 2 is a chart showing the cumulative percentage of particulates released after 12 days immersed in water of substrate samples produced in accordance with the present description compared to regular sodium silicates.

FIG. 3 is a photograph comparing the structural integrity of substrate samples produced in accordance with the present description compared to regular sodium silicates after 12 days immersed in water.

FIG. 4 is a photograph of the samples of FIG. 3 taken from an alternate perspective.

FIG. 5 is a chart showing the mechanical strength performance of substrate samples produced in accordance with the present description compared to regular sodium silicates.

FIG. 6 is of a photomicrograph of a sodium silicate sample prepared for the characterization study.

FIG. 7 is of a photomicrograph of a hydrated sodium silicate aluminate sample prepared for the characterization study.

FIG. 8 is of a photomicrograph of a hydrated sodium silicate aluminate gelled with 15 wt % dolomite sample prepared for the characterization study.

FIG. 9 is an Energy Dispersve X-ray Spectroscopy (EDS) scan taken for position 2 labeled in FIG. 8.

FIG. 10 is an EDS scan taken for position 4 labeled in FIG. 8.

FIG. 11 is an EDS scan taken for position 9 labeled in FIG. 8.

FIG. 12 is an EDS scan taken for position 16 labeled in FIG. 8.

FIG. 13 is a Thermalgravimetric (TGA)-Differential Scanning calorimetry (DSC) analysis graph prepared for the sample of FIG. 6.

FIG. 14 is a TGA-DSC analysis graph prepared for the sample of FIG. 7.

FIG. 15 is a TGA-DSC analysis graph prepared for the sample of FIG. 8.

### DETAILED DESCRIPTION

The following description is of exemplary embodiments of binder agents and methods of making and using said binder agents. This description is not to be taken in a limiting sense but is made merely for the purpose of describing the general principles and features of various aspects of the present invention. The scope of the present invention is not limited by this description.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

All references to singular characteristics or limitations of the present disclosure shall include the corresponding plural characteristic(s) or limitation(s) and vice versa, unless otherwise specified or clearly implied to the contrary by the context in which the reference is made.

As used herein (when used in this application, including the claims), the terms “a,” “an,” and “the” refer to “one or more.” The use of the word “a” or “an” when used in conjunction with the term “comprising” in the claims and/or the specification may mean “one,” but it is also consistent with the meaning of “one or more,” “at least one,” and “one or more than one.”

All combinations of method or process steps as used herein can be performed in any order, unless otherwise specified or clearly implied to the contrary by the context in which the referenced combination is made.

The methods and devices of the present disclosure, including components thereof, can comprise, consist of, or consist essentially of the essential elements and limitations of the embodiments described herein, as well as any additional or optional components or limitations described herein or otherwise useful.

As used herein, “alkali metal silicate” is a compound with a chemical formula X SiO₂:M₂O, where M is an alkali metal (e.g., lithium, sodium, potassium, etc.) and X is the molar ratio of the silicate.

As used herein, a component being “enriched” with another component may refer to the second component being added to the first component.

As used herein, “aluminum-based compound” is a chemical substances that contain aluminum (Al) as a primary element in their structure. These compounds can include a variety of forms, such as but not limited to, oxides (e.g., aluminum oxide), hydroxides (e.g., aluminum hydroxide), and salts (e.g., aluminum sulfate).

Embodiments may relate to alkali metal silicate-based inorganic binder agents enriched with one or more aluminum-based compounds. In particular, alkali metal silicates and the aluminum compounds may combine to form hydrated silicate (e.g., sodium silicate) aluminate binder agents. Due to incorporation of the aluminum compounds into the silicate structure, binders formed from the binder agents may include a robust and water-resistant binder matrix. The binders may desirably exhibit improved mechanical strength and/or water resistance when compared to regular, or commercially available, alkali metal silicate (e.g., sodium silicate) binders. Notably, sodium silicate binders often have considerable mechanical strength but are easily disintegrated when exposed to water.

The alkali metal silicate may be selected from the group consisting of sodium silicate (SiO₂:Na₂O), potassium silicate (SiO₂:K₂O), and mixtures thereof. In embodiments including sodium silicate, the sodium silicate may have a molar ratio of SiO₂:Na₂O of from 1.1 to 1.8. In embodiments including potassium silicate, the potassium silicate may have a molar ratio of SiO₂:K₂O of from 1.1 to 1.35.

The aluminum-based compounds may be selected from the group consisting of aluminum oxide (Al₂O₃), aluminum hydroxide (Al(OH)₃), alkaline aluminate (MAlO₂, wherein M is an alkali metal such as sodium), aluminum sulfate (Al₂(SO₄)₃), aluminum chloride (AlCl₃), and/or mixtures thereof. In some embodiments, the aluminum-based compounds is aluminum oxide or aluminum hydroxide.

The binder agent may include at least 0.1% by weight and no greater than 4.5% by weight of the aluminum-based compounds.

As nonlimiting examples, the binder agent may include at least 0.1% by weight, at least 0.5% by weight, at least 1.0% by weight, at least 1.5% by weight, at least 2.0% by weight, at least 2.5% by weight, at least 3.0% by weight, at least 3.5% by weight, at least 4.0% by weight and/or the like, of aluminum-based compounds. As further nonlimiting examples, the binder agent may include no greater than 4.5% by weight, no greater than 4.0% by weight, no greater than 3.5% by weight, no greater than 3.0% by weight, no greater than 2.5% by weight, no greater than 2.0% by weight, no greater than 1.5% by weight, no greater than 1.0% by weight, no greater than 0.5% by weight and/or the like, of aluminum-based compounds.

The binder agent may also include at least one inorganic component. The inorganic component may include one or more carbonates (e.g., dolomite, calcite, aragonite, natural or precipitated calcium carbonate, magnesium carbonate, limestone), one or more clay minerals (e.g., kaolinite, kaolin, metakaolin, halloysite, bentonite), one or more oxide minerals (e.g. calcium oxide, magnesium oxide), one or more sulfate minerals (e.g., gypsum, anhydrite), one or more phosphate minerals (e.g., apatite), one or more cementitious/pozzolanic materials (e.g., cement, fly ash, blast furnace slag), and mixtures thereof. In particular, the hydrated silicate aluminate may act as a hardening agent for the component(s), such that the aluminate may contribute to or accelerate the setting and/or hardening process by participating in chemical reactions that form solid crystalline or amorphous phases.

The binder agent may also include at least one organic component. The organic component may include one or more saccharides, one or more polyacrylamides, styrene butadiene, one or more polyvinyl alcohols, one or more polyacrylamides, and/or mixtures thereof.

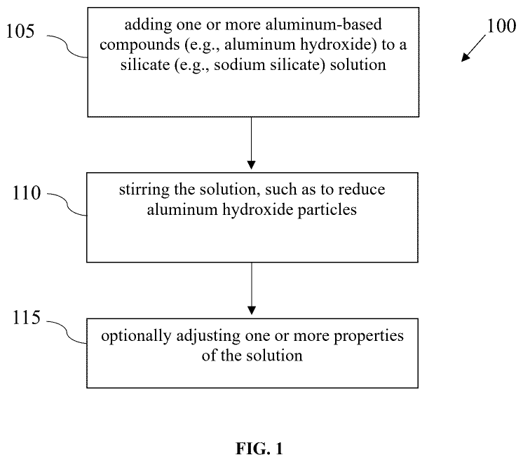

Embodiments may also relate to a method for preparing a hydrated silicate aluminate binder agent, as defined above. FIG. 1 depicts an exemplary embodiment of a method 100. At step 105, the method 100 may include adding aluminum-based compound(s), such as aluminum hydroxide, to a silicate solution, such as a sodium silicate solution. Although method 100 may be described as including aluminum hydroxide, it is contemplated that aluminum hydroxide may wholly or partially replaced by aluminum oxide, alkaline aluminate, or other aluminum-based compound(s).

The aluminum-based compound may be added to the silicate solution in a controlled manner, such as at a controlled temperature and/or controlled amount. In some embodiments, the aluminum-based compound may be added to the silicate solution at a temperature greater than 50° C. In some embodiments, between 2% by weight and 12% by weight of the aluminum-based compound may be added to the silicate solution. In some embodiments, the aluminum-based compound is added to the silicate solution in a gradual manner to avoid insolubility of the aluminum compound and/or precipitation of zeolite.

In some embodiments, the silicate solution has a mass ratio of 1.1-1.8 and/or a solids concentration of 30-55% by weight.

At step 110, the resulting solution from step 105 is stirred. In some embodiments, the solution is stirred vigorously to reduce the aluminum hydroxide particles and facilitate their reaction with the silicate.

At step 115, the resulting solution from step 110 may optionally be altered to adjust one or more properties of the solution. In some embodiments, one or more of the solids concentration, viscosity, and/or molar ratio may be adjusted. In some embodiments, the properties are adjusted by adding a silicate solution to the solution from step 110. The silicate solution may have a mass ratio of 1.1-1.8 and/or a solids concentration of 30-55% by weight. It is contemplated that the aluminum compounds may be completely solubilized before step 115.

In some embodiments, the binder composition from step 115 includes one or more of:
a molar ratio between 1.30 and 1.67;
a viscosity between 550 and 4500 centipoise; and/or
a solids concentration of 30-55% by weight.

The studies of hydrated sodium silicate aluminate were carried out in comparative tests with commercial sodium silicates in the laboratory, evaluating in particular the mechanical strength and water resistance of the substrates.

Various tests have been carried out to demonstrate embodiments described herein. The following examples illustrate the results of these tests, which were carried out using hydrated sodium silicate aluminate as a binder agent for sand and potassium chloride fines.

### EXAMPLES

### Example 1

As an example of embodiments described herein, but without limitation, four specimens were produced from a mixture of 10% binder and 90% sand fines. These samples were then molded in a hydraulic press machine at 40 bar pressure and heated in a lab oven at 100° C. for one hour for a dehydration process. The compositions of specimens are as follows:
(a) Regular alkaline silicate with a mass ratio of 2.1;
(b) Regular neutral silicate with a mass ratio of 3.3;
(c) Hydrated sodium silicate aluminate; and
(d) Hydrated sodium silicate aluminate with carbonate minerals over 15% by weight of the hydrated sodium silicate aluminate.

The specimens were immersed in water and a quantitative test was performed on a daily basis for 12 days to measure the solid particles of the agglomerate that were released over time. Table 1 sets forth the results of this test.

TABLE 1

| | Regular | Hydrated | Hydrated Sodium | Regular |
|---|---|---|---|---|
| | Alkaline | Sodium | Silicate | Neutral |
| | Silicate mass | Silicate | Aluminate + | Silicate mass |
| Time | ratio 2.1 | Aluminate | carbonates minerals | ratio 3.3 |
| Day 1 | 100% | 0.054% | 0.002% | 0.001% |
| Day 2 | | 0.075% | 0.150% | 0.235% |
| Day 3 | | 0.089% | 0.370% | 5.790% |
| Day 4 | | 1.03% | 0.677% | 12.86% |
| Day 5 | | 1.22% | 1.35% | 34.31% |
| Day 6 | | 1.67% | 1.97% | 53.59% |
| Day 7 | | 1.85% | 2.22% | 62.37% |
| Day 8 | | 2.07% | 2.30% | 71.09% |
| Day 9 | | 2.09% | 2.37% | 72.50% |
| Day 10 | | 2.10% | 2.49% | 74.10% |
| Day 11 | | 2.14% | 2.52% | 75.19% |
| Day 12 | | 2.14% | 2.52% | 77.39% |

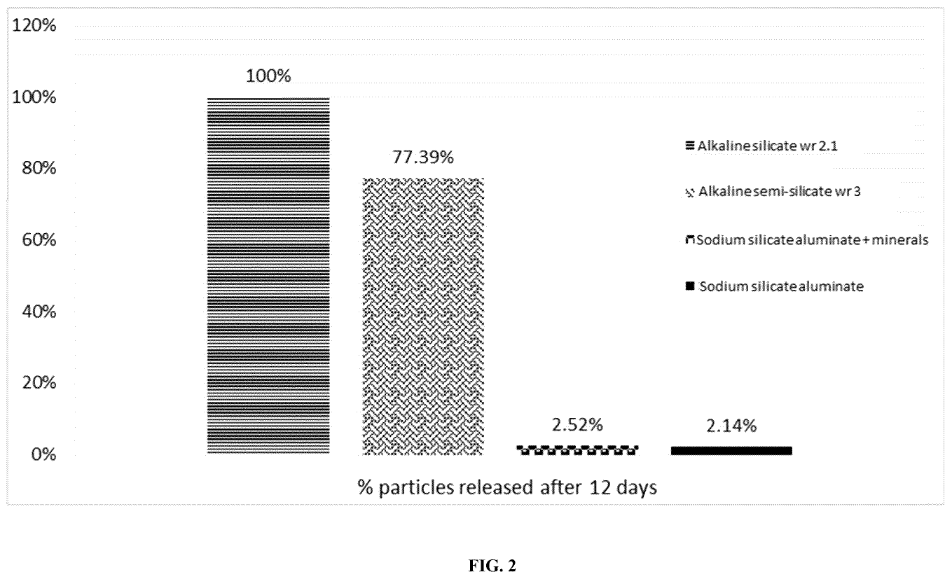

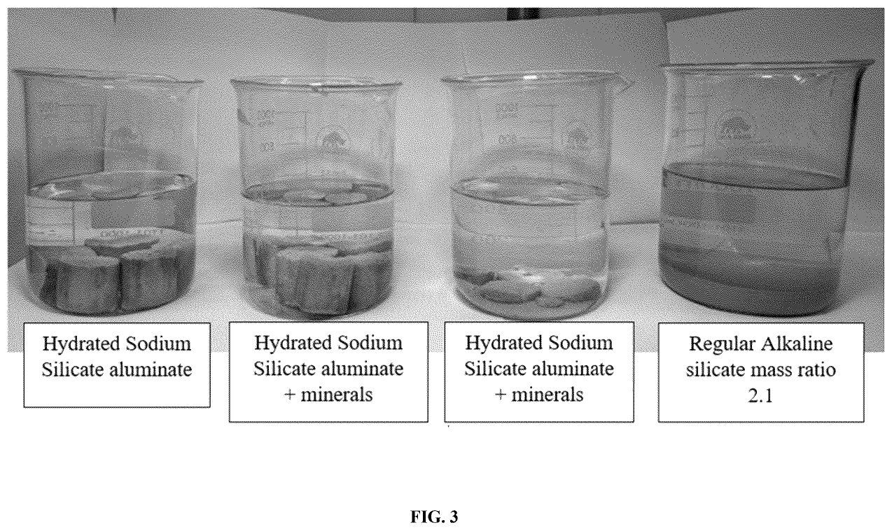

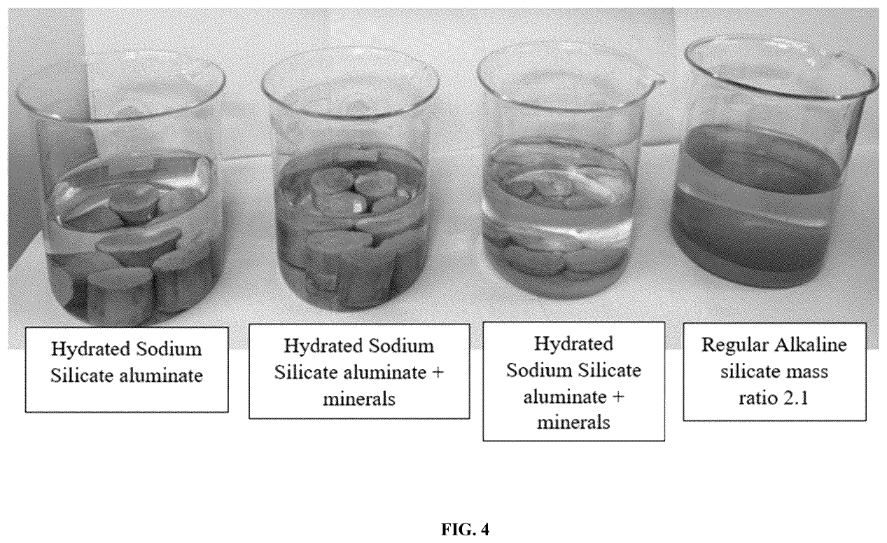

FIG. 2 is a bar chart showing the results of the quantitative test on the twelfth day. As shown in FIG. 2, the two hydrated sodium silicate aluminate binders provided significant improvement over regular silicates with regard to maintaining the specimens intact against the action of water. FIG. 3 and FIG. 4 visually demonstrate the strength of the hydrated sodium silicate binders to maintain their integrity. The specimens prepared using hydrated sodium silicate aluminate, either with or without added minerals, produce specimens able to withstand the action of water.

### Example 2

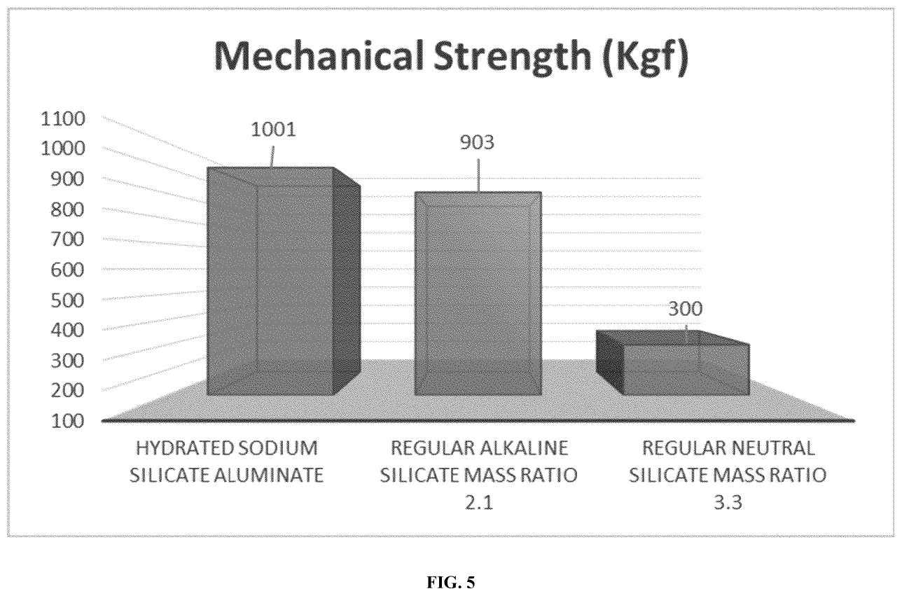

As an example of embodiments described herein, but without limitation, specimens were produced from a mixture of 10% binder and 90% sand fines, which were then molded in a hydraulic press machine at 40 bar pressure and heated in a lab oven at 100° C. for one hour for a dehydration process. The specimens were subjected to a mechanical strength performance versus the regular sodium silicates, the results of which are shown in FIG. 5.

This example shows the advantage of the binder of this invention over regular sodium silicates, especially with regard to mechanical resistance. For this trial, the mineral was not added to hydrated sodium silicate aluminate because the function is only related to waterproofing performance. For mechanical strength, the hydrated sodium silicate aluminate provides higher mechanical strength performance.

### Characterization Study

A characterization study was performed on 3 samples:
(a) a regular sodium silicate which was converted to a hydrous powder by drying;
(b) a hydrated sodium silicate aluminate which was converted to a hydrous powder by drying; and
(c) a 85% mass of hydrated sodium silicate aluminate gelled with 15% mass of dolomite which was obtained by gelation of part A hydrated silicate and part B dolomite.

Characterization work consisted of an electron microscope examination and a TGA-DSC thermal analysis.

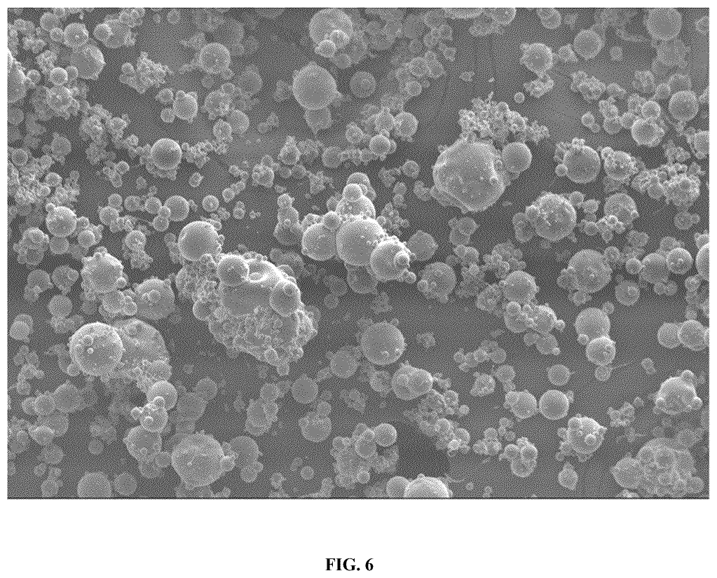

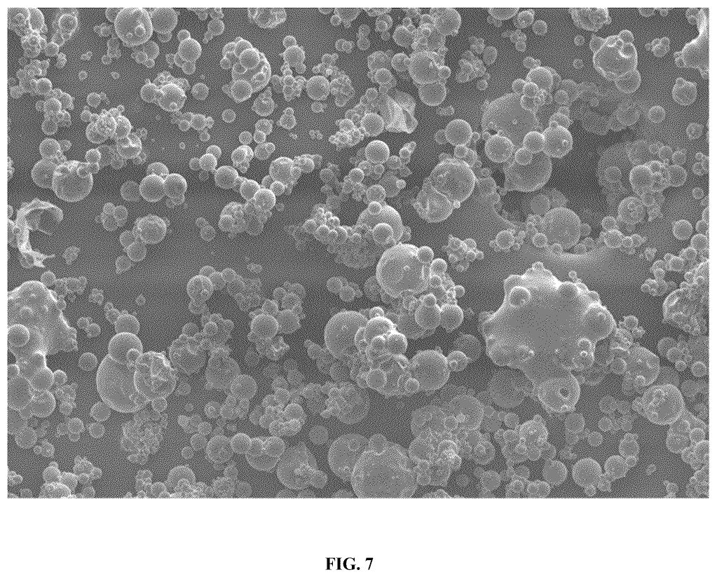

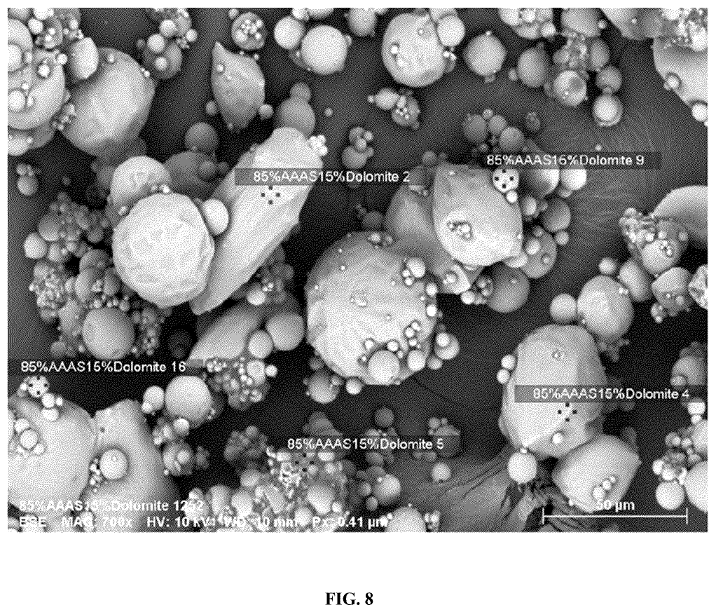

The results of the electron microscope examination are shown in FIG. 6, FIG. 7, and FIG. 8. The SEM-pictures in FIG. 6 and FIG. 7 appear similar, whereas in FIG. 8, similar particles can be seen at most positions. However, the particles labelled as positions 2 and 4 in FIG. 8 are different in appearance, being less spherical with more rectangular sides.

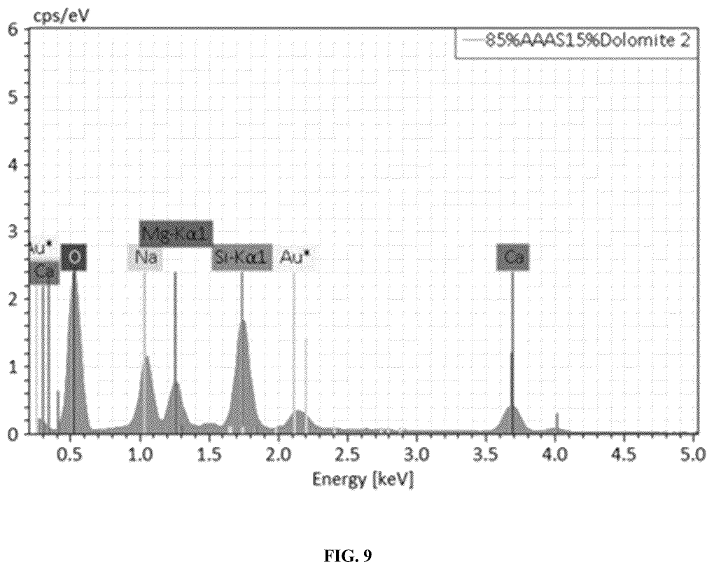

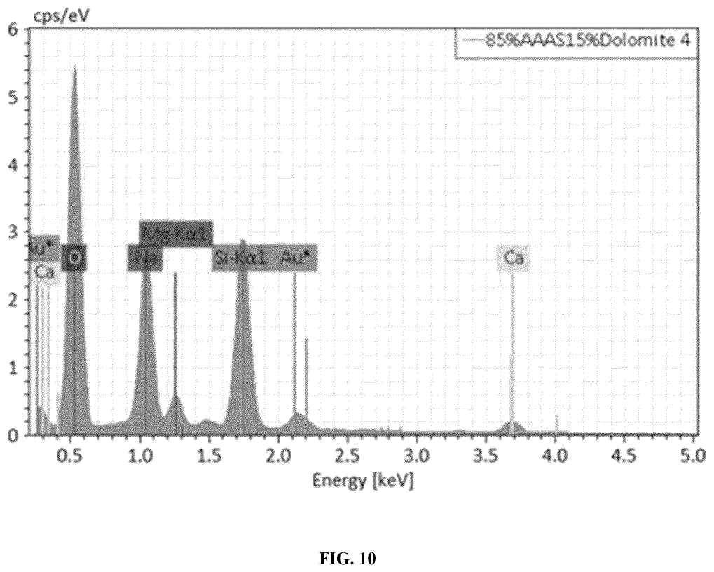

To obtain a better understanding of the particles, an EDS was used to scan the elemental composition at four locations shown in FIG. 8: labelled positions 2, 4, 9 and 16. The scans for positions 2 and 4 are shown in FIG. 9 and FIG. 10, respectively. Note that the gold (Au) originates from the coating of the sample prior to putting it in the SEM. The detection of Mg and Ca at positions 2 and 4 suggests that the particles scanned at these positions are dolomite particles. The EDS also detects some Si, suggesting that the dolomite particles are encapsulated in silicate.

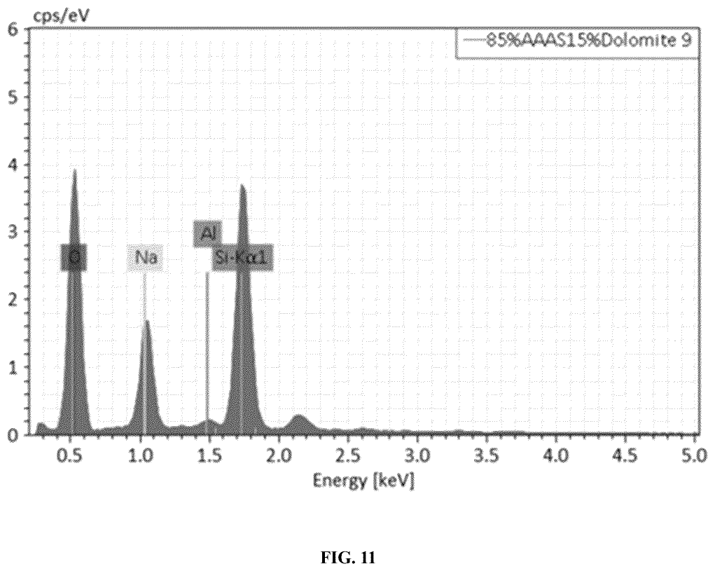

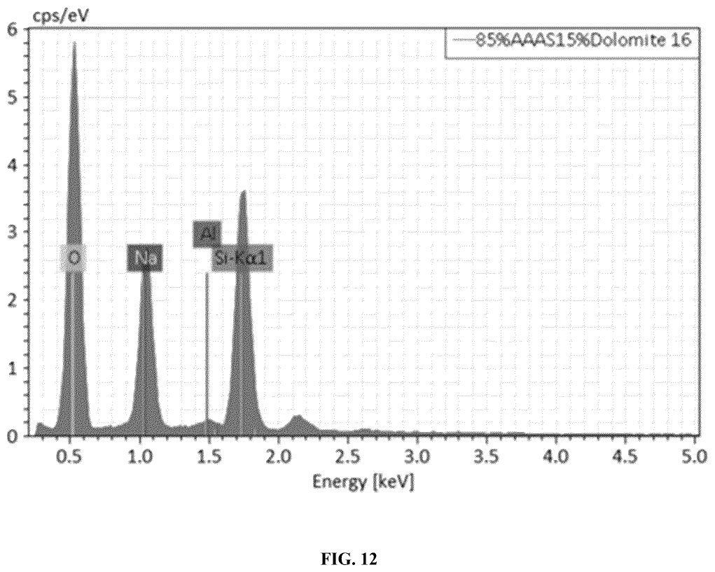

The EDS scans for positions 9 and 16 are shown in FIG. 11 and FIG. 12, respectively. Neither Ca nor Mg is detected here, but small amounts of Al are, showing that these are hydrated sodium silicate aluminate.

A TGA-DSC thermal scan was employed to detect phase behavior and phase changes in the material. Small samples were taken and heated at a constant rate of 10° C./min from room temperature (20° C.) to 1000° C. The amount of heat absorbed or lost by the sample is measured together with any weight loss/gain. Phase change behavior can then be detected if there is substantial endothermic or exothermic behavior without change in mass of the sample.

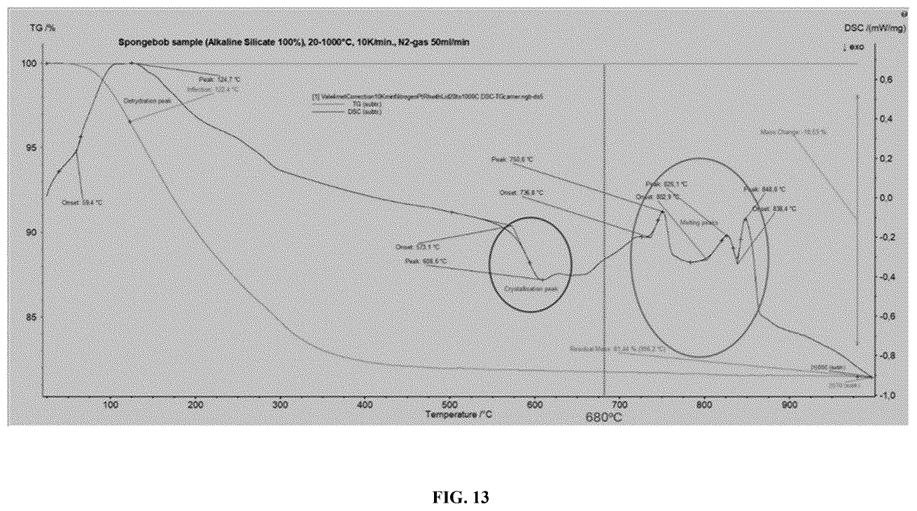

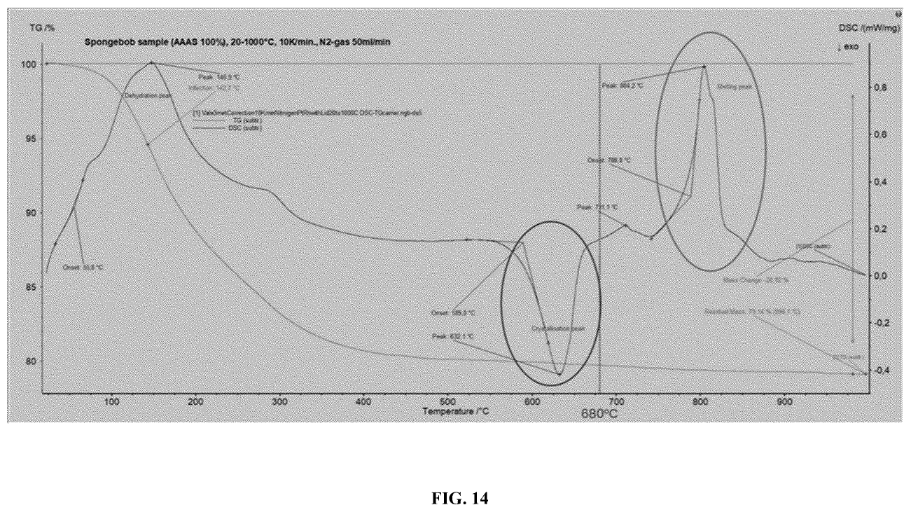

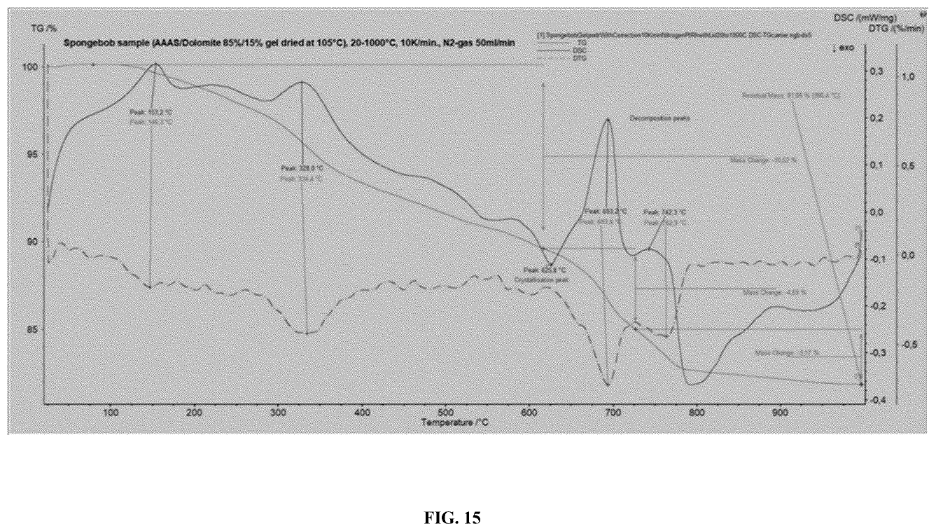

Results for the TGA-DSC thermal analysis of the sodium silicate sample are shown in FIG. 13. Results for the TGA-DSC thermal analysis of the hydrated sodium silicate aluminate sample are shown in FIG. 14. Results for the TGA-DSC thermal analysis of the 85% mass of hydrated sodium silicate aluminate gelled with 15% mass of dolomite sample are shown in FIG. 15.

In all of the TGA-DSC curves, the green line denotes the weight of the sample in the TGA and the blue line denotes the heat flux as measured by the DSC. A peak in the blue line indicates an endothermic effect. A valley in the blue line indicates an exothermic effect. FIG. 13 and FIG. 14 show an endothermic weight effect between 100 and 200° C. FIG. 15 shows a similar weight effect but the peak in the DSC is less pronounced, and the weight loss occurs over a wider temperature range. As this weight loss is related to drying of the material, this suggests that the gelation results in a stronger binding of the water in the product.

The characterization study shows that the sodium silicate sample, the hydrated sodium silicate aluminate sample, and the 85% mass of hydrated sodium silicate aluminate gelled with 15% mass of dolomite sample are different products. The water resistance and increased strength of the hydrated sodium silicate with or without dolomite is attributable to the fact that the samples are indeed different products from regular sodium silicate.

### Example 3

The binding strength of hydrated sodium silicate aluminate can be enhanced with the addition of hardening agents such as cement, calcium oxide, magnesium oxide, dolomite or pozzolanic material such as fly ash, ground granulated blast furnace slag, metakaolin among others. Alternatively, organic-based binders such as saccharides, polyacrylamides, styrene butadiene, polyvinyl alcohols, polyacrylamides, among others can be combined with the hydrated sodium silicate aluminate to further enhance performance. For example, it is desirable that early strength be achieved without the application of heat. Thus, in this example, specimens were produced under ambient temperature (22° C., room temperature (RT)). It is also desirable to maintain binder strength under tropical conditions, such as 40° C. with 85% relative humidity (rh). Briquettes were prepared by mixing hydrated sodium silicate aluminate at a rate of 2.91% by weight hardener, and/or 2 or 3% organic binder by weight with the balance being the weight of sand fines. The mixed material was placed in a die and pressed to a pressure of at 391 bar. Table 2 shows higher initial strength (at 0 min) and higher early strength at 1 hour under ambient temperature as well as 40° C. and 85% relative humidity.

TABLE 2
Compressive strength (N/cm²) results of sand samples
made with sodium silicate aluminate binder with
hardener and/or organic-based co-binders.

| Sodium silicate aluminate | | | at 40° C. |
|---|---|---|---|
| with different co-binder | 0 min | RT 1 hr | 85% rh-1 hr |
| No hardener or co-binder | 0.2 | 0.3 | 0.3 |
| +3% by weight corn syrup | 0.6 | 17.3 | 0.8 |
| +3% by weight molasses | 0.2 | 14.9 | 2.7 |
| +2% by weight dolomite | 0.2 | 4.7 | 0.7 |
| +2% by weight calcium oxide | 0.3 | 6.5 | 10.4 |
| +1% by weight cement | 0.16 | 1.8 | 3.8 |
| +2% by weight cement | 0.18 | 6.9 | 6.8 |
| Calcium oxide-polyvinyl | 0.6 | 1.1 | 2.1 |
| alcohol | | | |
| Calcium oxide-styrene- | 1.0 | 1.3 | 3.9 |
| butadiene | | | |
| Calcium oxide- | 0.6 | 3.8 | 13.2 |
| polyacrylamide | | | |

### Example 4a

To further illustrate that hydrated sodium silicate aluminate is a modified and unique form of sodium silicate, a comparison was made with alkaline silicate blended with sodium aluminate and caustic to match the exact chemical composition of hydrated sodium silicate aluminate (Blended Na—Si—AlO₂). Potassium chloride was selected as powder material to be agglomerated. Regular sodium silicates were used as controls. Recognizing there are differences in solids contents between the silicates, the binder loading was adjusted to give the same active solid content as 2.91% w/w of sodium silicate aluminate. The silicate binders were mixed with potassium chloride and then placed in a die and pressed to a pressure of 391 bar. Agglomerated samples were cured under ambient conditions (22° C., RT) or placed in an environmental chamber which set at 40° C. with 85% relative humidity. As well as demonstrating better binder performance vs. regular sodium silicates, the example shows hydrated sodium silicate aluminate is an innovative form of silicate and more than its individual component material.

TABLE 3
Compressive strength (N/cm²) results of KCl samples
made with equivalent active solids content

| | | | at 40° C. |
|---|---|---|---|
| | | | 85% rh- |
| Binder | 0 min | RT 1 hr | 1 hr |
| Sodium silicate | 24.8 | 45.6 | 47.1 |
| aluminate | | | |
| Alkaline silicate wr2.1 | 16.2 | 50.1 | 21.6 |
| Alkaline silicate wr3.3 | 10.0 | 32.4 | 19.0 |
| Blended Na—Si—AlO2 | 14.5 | 45.2 | 26.3 |

### Example 4b

The binding performance of hydrated sodium silicate aluminate enhanced with hardening agents and/or co-binders is compared against regular silicates as well as alkaline silicate blended with sodium aluminate. The hydrated sodium silicate aluminate was added at a rate of 2.91% binder, additional 2 or 3% additive was mixed into the potassium chloride, followed by the same procedures described above.

TABLE 4
Compressive strength (N/cm²) results of KCl samples
made with different silicate binders and co-binders

| | | | | at 40° C. |
|---|---|---|---|---|
| | Co-binder/ | | | 85% rh- |
| Binder | Hardener | 0 min | RT 1 hr | 1 hr |
| Sodium silicate | +3% by | 34.5 | 69.8 | 39.1 |
| aluminate | weight corn | | | |
| Alkaline silicate wr2.1 | syrup | 23.2 | 54.6 | 27.0 |
| Alkaline silicate wr3.3 | | 10.8 | 20.6 | 15.4 |
| Blended Na—Si—AlO2 | | 15.3 | 45.9 | 17.0 |
| Sodium silicate | +3% by | 42.0 | 67.7 | 23.5 |
| aluminate | weight | | | |
| Alkaline silicate wr2.1 | molasses | 13.8 | 29.1 | 10.3 |
| Alkaline silicate wr3.3 | | 10.0 | 11.2 | 5.1 |
| Blended Na—Si—AlO2 | | 19.7 | 26.9 | 10.9 |
| Sodium silicate | +2% by | 25.8 | 38.1 | 38.5 |
| aluminate | weight | | | |
| Alkaline silicate wr2.1 | dolomite | 15.5 | 40.3 | 24.2 |
| Alkaline silicate wr3.3 | | 14.4 | 33.4 | 17.4 |
| Blended Na—Si—AlO2 | | 15.3 | 38.8 | 22.7 |

### Example 5

The agglomerating process requires the material to develop sufficient green strength to survive the agglomeration process and subsequent transportation to storage or use. This example further looks at early strength enhancement of the hydrated sodium silicate aluminate with co-binders and/or hardening agents. The example uses potassium chloride as the agglomerated material. Strength is measured at time 0 and also at 24 hours after ambient conditions of storage. The hydrated sodium silicate aluminate was reduced to 1.45% weight as the binder. The hardener or co-binder was either mixed into the hydrated sodium silicate aluminate or add to the potassium chloride, followed by pressing using the same procedures described above.

TABLE 5
Compressive strength (N/cm²) at time 0 and 24 hrs.
with KCl briquetted hydrated sodium silicate aluminate
and different hardeners/co-binders.

| | 0 min | RT 1 day |
|---|---|---|
| No co-binder | 38.1 | 145.0 |
| 1% by weight cement | 45.9 | 182.8 |
| 1% by weight ground | 74.2 | 158.1 |
| granulated blast | | |
| furnace slag | | |
| 0.5% by weight dextrin | 102.6 | 203.4 |
| 1% by weight metakaolin | 82.8 | 190.3 |
| 0.5% by weight metakaolin | 85.5 | 171.3 |
| 0.5% by weight polyvinyl | 39.5 | 177.2 |
| alcohol | | |
| 1% by weight fly ash C | 48.9 | 212.3 |

Although the description above contains specificities of the technology, they should not be interpreted as limitations to the scope of this invention, but as an example of a preferred embodiment. The scope of the present invention must be determined by the embodiments illustrated, but with the set of claims and its legal equivalents.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatus and methods of using and making the same disclosed herein have been discussed and illustrated, it is to be distinctly understood that the invention is not limited thereto but may be otherwise variously embodied and practiced within the scope of the following claims.

What is claimed is:

1. A hydrated silicate aluminate binder agent comprising:
an alkali metal silicate selected from the group consisting of sodium silicate and potassium silicate; and
aluminum oxide.

2. The binder agent of claim 1, wherein the alkali metal silicate is sodium silicate having a molar ratio of SiO₂:Na₂O of from 1.1 to 1.8.

3. The binder agent of claim 2, wherein the aluminum oxide is present in an amount of from 0.1 to 4.5% by weight of the agent.

4. The binder agent of claim 1, wherein the alkali metal silicate is potassium silicate having a molar ratio of SiO₂:K₂O of from 1.1 to 1.35.

5. The binder agent of claim 4, wherein the aluminum oxide is present in an amount of from 0.1 to 4.5% by weight of the agent.

6. A hydrated sodium silicate aluminate binder agent comprising:
sodium silicate having a molar ratio between 1.1 and 1.8; and
at least one aluminum-based compound selected from the group consisting of aluminum oxide, aluminum hydroxide, sodium aluminate, aluminum sulfate, and aluminum chloride.

7. The binder agent of claim 6, further comprising:
at least one inorganic component selected from the group consisting of carbonates, oxides, clay minerals, sulfate minerals, phosphate minerals, cementitious or pozzolanic materials, and mixtures thereof.

8. The binder agent of claim 7, wherein the at least one inorganic component includes carbonates selected from the group consisting of dolomite, calcite, aragonite, natural or precipitated calcium carbonate, magnesium carbonate, limestone, and mixtures thereof.

9. The binder agent of claim 7, wherein the at least one inorganic component includes clay minerals selected from the group consisting of kaolinite, kaolin, metakaolin, halloysite, bentonite, and mixtures thereof.

10. The binder agent of claim 7, wherein the at least one inorganic component includes sulfate minerals selected from the group consisting of gypsum, anhydrite, and mixtures thereof.

11. The binder agent of claim 7, wherein the at least one inorganic component includes phosphate minerals, wherein the phosphate minerals include apatite.

12. The binder agent of claim 7, wherein the at least one inorganic component includes cementitious or pozzolanic materials selected from the group consisting of cement, fly ash, blast furnace slag, and mixtures thereof.

13. A method of producing a hydrated sodium silicate aluminate binder agent, the method comprising:
adding at least one aluminum-based compound selected from the group consisting of aluminum hydroxide, alkaline aluminate, and aluminum oxide, to a sodium silicate solution having a molar ratio between 1.1 and 1.8; and
mixing the solution to reduce aluminum hydroxide particles and facilitate reaction between the aluminum hydroxide particles and sodium silicate, thus forming the hydrated sodium silicate aluminate binder agent.

14. The method of claim 13, wherein adding the at least one aluminum-based compound to the sodium silicate solution comprises adding between 2 and 12% by weight of aluminum hydroxide to the sodium silicate solution at a temperature greater than 50° C.

15. The method of claim 13, further comprising:
adjusting one or more properties of the hydrated sodium silicate aluminate binder agent, wherein the one or more properties are selected from the group consisting of:
solids concentration of the aluminate, wherein the solids concentration is adjusted to be between 30-55% by weight,
viscosity of the aluminate, wherein the viscosity is adjusted to be between 550 and 4500 centipoise, and
molar ratio of the aluminate, wherein the molar ratio is adjusted to be between 1.30 and 1.67.
